(19) United States
(12) Patent Application Publication
(10) Pub. No.: US 2002/0041800 A1
(43) Pub. Date: Apr. 11, 2002

(54) Apparatus for automatic loading of sleeve on device testing apparatus

(75) Inventors: Won Kim, Kyonggi-do (KR); Yong-Jin Lim, Chungchongnam-do (KR); Byung Il Jung, Chollabuk-do (KR)

Correspondence Address: FLESHNER & KIM, LLP, P.O. Box 221200, Chantilly, VA, 20153-1200, US

(73) Assignee: MIRAE CORPORATION

(21) Appl. No.: 09/973,911

(22) Filed: Oct. 11, 2001

(30) Foreign Application Priority Data
Oct. 11, 2000 (KR) 2000-59768

(51) Int. Cl. B65G 65/34

(52) U.S. Cl. 414/413

(57) ABSTRACT

The present invention relates to an apparatus for automatic loading of a sleeve on a device testing apparatus, for automatic lining up and loading of a sleeve having a device held therein on a device testing apparatus for carrying out device test, including a sloped loading plate for putting sleeves each having devices held therein thereon, vertical fixation plates at both sides of the sloped loading plate, carrier means fitted so as to be in contact with a lower edge of the sloped loading plate, for holding the sleeves put on, and slid down to the lower edge of, the sloped loading part, and transporting to a loading part in the device testing apparatus one by one in succession, driver means fitted to the fixation plate for driving the carrier means, and return means for, when a plurality of sleeves on the sloped loading plate are loaded on, and transported by the step, returning the sleeves back to the sloped loading plate again, leaving only one of the sleeves.

### BACKGROUND OF THE INVENTION

1. Field of the Invention

The present invention relates to a testing apparatus for testing a device, and more particularly, to an apparatus for automatic loading of a sleeve on a device testing apparatus, for automatic loading of a sleeve having a device held therein on the device testing apparatus for carrying out device test.

2. Background of the Related Art

In general, the devices completed at a production line are subjected to test for defects before shipment. In the device testing apparatuses, there are horizontal device testing apparatuses, and vertical device testing apparatuses. The horizontal device testing apparatus makes horizontal loading of devices held in a plastic tray on a metal tray having an opened top or bottom surface, and horizontal transfer between testing steps, and tests the devices at a horizontal testing part. In the vertical device testing apparatus, upon stacking tube form of sleeves each having devices to be tested held therein on a stacker, transfer means takes, and tilts the sleeves one by one, so that the devices are dropped from the sleeve by gravity, and supplied to, and tested by, a vertical testing part in succession.

Since the present invention relates to an apparatus for automatic lining up and loading of the sleeves in the vertical device testing apparatus, a system and operation of a related art vertical device testing apparatus will be explained with reference to FIG. 1 attached herein, while explanation of the horizontal device testing apparatus is omitted.

Referring to FIG. 1, after stuffing devices to be tested in the sleeve 1, if the sleeves are loaded on a loader 4 in a loading part 3 in an upper part of the device testing apparatus in succession, a separate transfer device (not shown) takes the sleeves 1 one by one from a bottom of the loader 4, and transfers to a swing arm 5 which can swing to a preset angle, horizontally. Then, the swing arm 5 swings to the preset angle, for an example, 45°, such that the sleeve is pushed toward the transfer track 7 by an elastic force of the spring (not shown) at rear of an insert piece 6, bringing an opening of the sleeve onto a transfer track. According to this, the devices stuffed in the sleeve are dropped from the sleeve by gravity through the opening of the sleeve, transferred to the testing part 8, and subjected to a required testing at the testing part 8. The devices tested at the testing part are transferred to an unloading part 10, classified according to a test result, and put into empty sleeves la, and stacked at an unloading staking part 11 in succession by a transfer device (not shown).

However, the related art vertical device testing apparatus requires a worker to line up and load each of the sleeves on the loader 4 at required positions thereof in succession manually for loading the sleeves on the loading part 3, the loading of the sleeve has been very troublesome, with a poor working efficiency, and a subsequent poor test efficiency.

### SUMMARY OF THE INVENTION

Accordingly, the present invention is directed to an apparatus for automatic loading of a sleeve on a device testing apparatus that substantially obviates one or more of the problems due to limitations and disadvantages of the related art.

An object of the present invention is to provide an apparatus for automatic loading of a sleeve on a device testing apparatus, in which sleeves having devices to be tested held therein are loaded on the device testing apparatus, automatically.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the apparatus for automatic loading of a sleeve on a device testing apparatus includes a sloped loading plate for putting sleeves each having devices held therein thereon, vertical fixation plates at both sides of the sloped loading plate, carrier means fitted so as to be in contact with a lower edge of the sloped loading plate, for holding the sleeves put on, and slid down to the lower edge of, the sloped loading part, and transporting to a loading part in the device testing apparatus one by one in succession, driver means fitted to the fixation plate for driving the carrier means, and return means for, when a plurality of sleeves on the sloped loading plate are loaded on, and transported by the step, returning the sleeves back to the sloped loading plate again, leaving only one of the sleeves.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a side view of key parts of a related art vertical device testing apparatus;

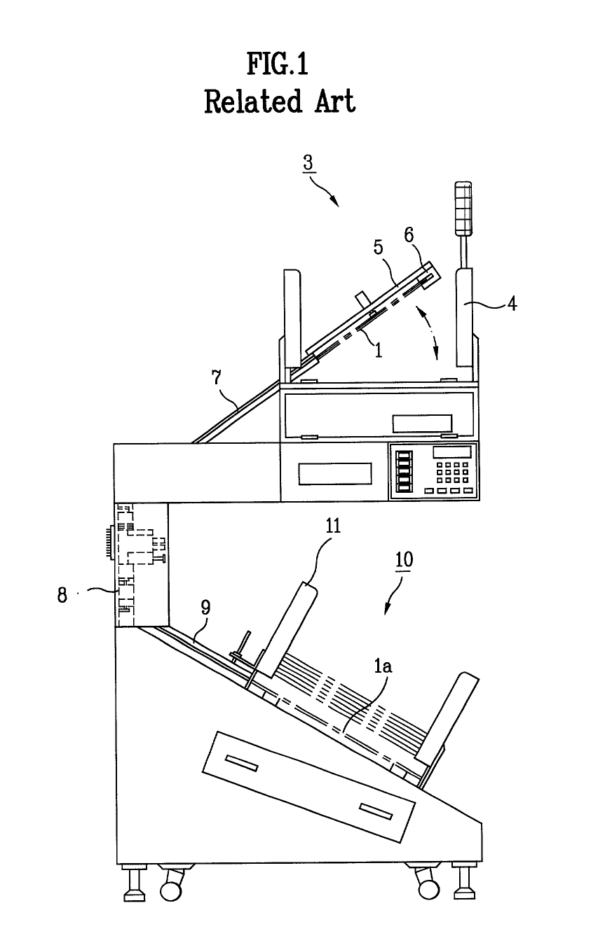

FIG. 2 illustrates a side view of key parts of a vertical device testing apparatus having an apparatus for automatic loading of a sleeve of the present invention applied thereto;

FIG. 3 illustrates a perspective view of an apparatus for automatic loading of a sleeve in accordance with a first preferred embodiment of the present invention; and,

FIG. 4 illustrates a side view of an apparatus for automatic loading of a sleeve in FIG. 3 for showing operation thereof.

### DETAILED DESCRIPTION OF THE PREFERRED EMBODIMENT

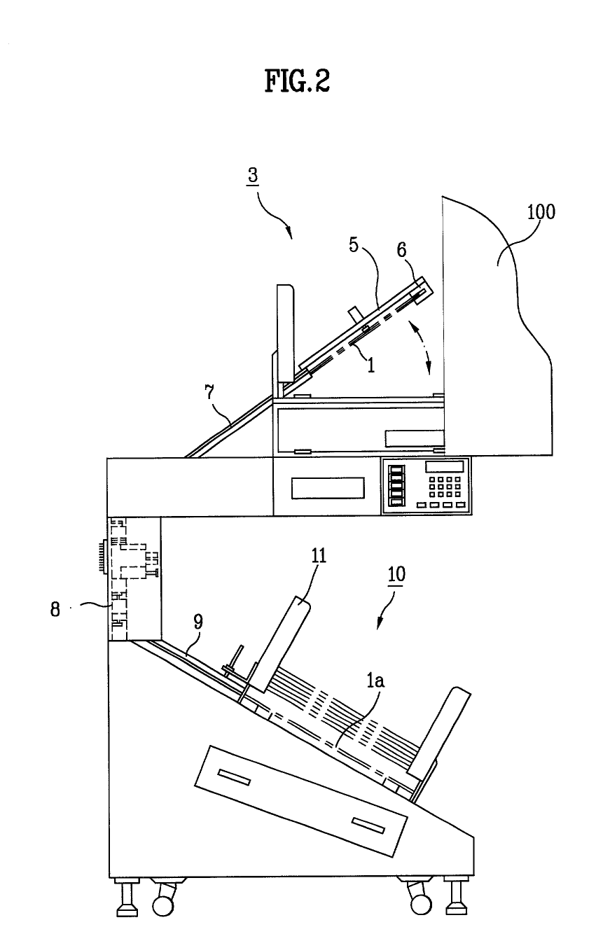

Reference will now be made in detail to the preferred embodiments of the present invention, examples of which are illustrated in the accompanying drawings. FIG. 2 illustrates a side view of key parts of a vertical device testing apparatus having an apparatus for automatic loading of a sleeve of the present invention applied thereto. The apparatus 100 for automatic loading of a sleeve of the present invention is mounted at one side of the loading part 3 in an upper part of the device testing apparatus, for automatic lining up, and supplying sleeves ‘S’ stuffed with devices to be tested to the loading part 3.

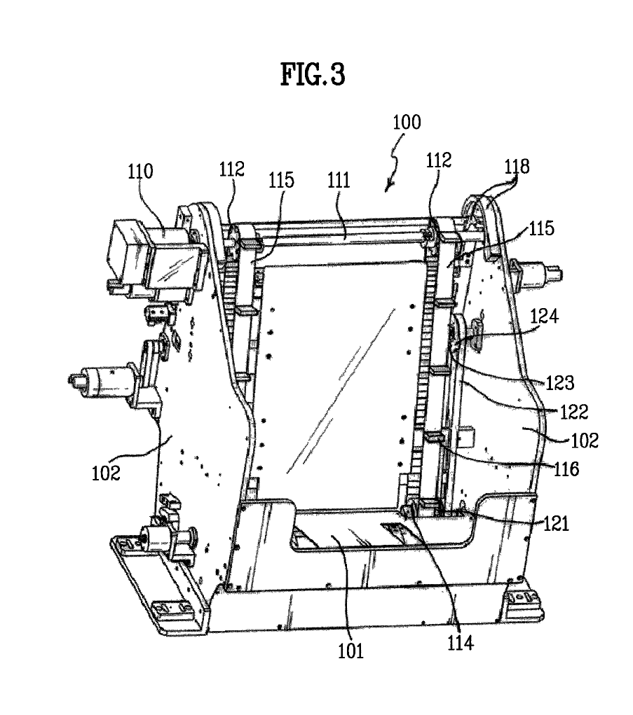

FIG. 3 illustrates a perspective view of an apparatus for automatic loading of a sleeve in accordance with a first preferred embodiment of the present invention.

Referring to FIG. 3, there is a sloped loading plate 101 sloped backward in a lower part of the apparatus 100 for automatic loading for placing the sleeves thereon, and vertical fixation plates 102 on both sides of the sloped loading plate 101. There is carrier means right behind the sloped loading plate 101 for holding and transporting the sleeves on the sloped loading plate 101, and a loading standby part (not shown) in rear of the carrier means for temporary loading of the sleeves transported by the carrier means thereon for standing-by until the sleeves are transported and loaded on the loading part 3 in rear of the apparatus.

In the meantime, the carrier means has a system similar to a conveyer system, for transporting the sleeves slid down to a rear corner of the sloped loading plate by gravity upward one by one, and therefrom, to the sleeve loading standby part in rear of the carrier means, as follows.

There are a motor 110 on an outside of one of the fixation plates 102, a driver shaft 111 fitted across upper parts of the fixation plates 102 having one end rotatably coupled to the motor 110, and one pair of upper pulleys 112 fixed to both ends of the driver shaft 111 for rotation together with the driver shaft 111.

There are a follower shaft 113 rotatably fitted to lower parts of the fixation plates 102 parallel to the driver shaft 111, with one pair of lower pulleys 114 on both ends of the follower shaft 113, for receiving a rotation force through the upper pulleys 112 on the drive shaft 111, and conveyor belts 115.

The conveyor belt 115 is fitted so as to be almost in contact with a rear edge of the sloped loading plate 101, and has steps 116 fitted on an outside surface thereof at fixed intervals along a length direction of the conveyor belt 115 for lifting and carrying the sleeves. It is preferable that the conveyor belt 115 has an angle greater than 90° with respect to floor for safe transportation of the sleeves. There are guide rails 118 at top of inside of the fixation plate 102 for guiding the sleeves transported by the conveyor belts 115 toward the loading part in rear of the carrier means.

In the meantime, the apparatus for automatic loading of a sleeve on a device testing apparatus of the present invention includes return means for taking sleeves loaded on one of the steps 116 away from the step 116 leaving only one of the sleeves on the step 116, and returning the sleeves to the sloped loading plate 101 again in the middle of the transportation in a case a plurality of sleeves are loaded on, and transported by the step 116, because the apparatus of the present invention is designed such that the loading standby part (not shown) can not handle more than one sleeve at a time to cause malfunction if the conveyor belt 115 carries more than one sleeves to the loading standby part (not shown) at a time.

The return means includes a second lower pulley 121 fixed to the follower shaft 113 at an outer side of the lower pulley 114 in the carrier means for rotation with the follower shaft 113, and a return pulley 123 rotatably fitted to a middle part of an inner side of the fixation plate 102 so as to be positioned at an outer side of the conveyor belt 115, connected to the second lower pulley 121 through a driving belt 122 for rotation with the second lower pulley 121.

The return pulley 123 has a projection 124 at an outside circumference, which is projected to a surface of the conveyor belt for hitting upper sleeves to fall off the step 116 when a plurality of sleeves are loaded on the step 116 of the conveyor belt 115. In this instance, the projection 124 from the return pulley 123 is designed such that the projection 124 leaves the sleeve intact when only one sleeve is loaded on the step 116, and hits only upper sleeves ‘S’ to fall off the step 116 when a plurality of sleeves are loaded on the step 116, by designing each of the intervals of the steps 116 on the conveyor belt 115 within a preset value with respect to a diameter of the return pulley 123.

The operation of the foregoing apparatus for automatic loading of a sleeve on a device testing apparatus of the present invention will be explained.

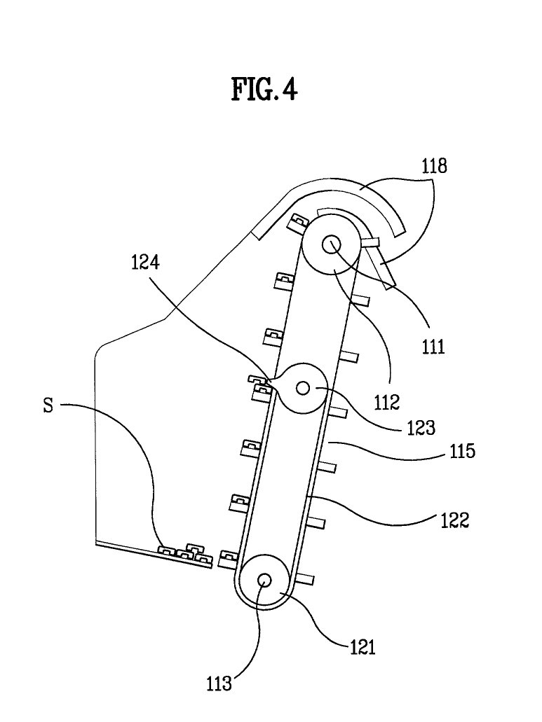

Upon putting down a plurality of sleeves each stuffed with devices on the sloped loading plate 101, the sleeves on the sloped loading plate 101 slides down to a lower end of the sloped loading plate 101 by gravity. Then, as shown in FIG. 4, the sleeve ‘S’ slid down to a corner of the lower end of the sloped loading plate 101 is caught by the step 116 on the conveyor belt 115, and transported upward, and another sleeve is caught by the next step 116 on the conveyor belt 115, to transport the sleeves in succession. Therefore, as the sleeves ‘S’ are transported upward by the conveyor belt 115 one by one automatically once the sleeves ‘S’ are put down on the sloped loading plate 101 by the user, the user is not required to line up the sleeves.

In the meantime, the sleeve ‘S’ transported by the conveyor belt 115 is guided by the guide rails 118 as both ends of the sleeve ‘S’ are inserted in the guide rails 118 at top of the fixation plate 102, and dropped, lined up on a sleeve loading standby part (not shown) in rear of the apparatus in succession, and transferred to the swing arm 5 (see FIG. 2) by a separate sleeve conveyor (not shown) in rear of the apparatus for automatic loading of a sleeve. Then, the devices held in the sleeves transferred to the swing arm 5 are loaded on, and tested at the testing part 8 (see FIG. 2) according to a process as explained in the related art.

In the meantime, when the conveyor belt 115 is in operation, the return pulley 123 of the return means at outer side of the conveyor belt rotates too, wherein if a plurality of sleeves, for an example, two sleeves, are transported with the two sleeves loaded on one step 116 on the conveyor belt 115 at a time, the projection 124 hits an upper sleeve ‘S’ to fall off the step 116 as the return pulley 123 rotates, and drop down onto the sloped loading plate 101, again. Thus, by the foregoing action of the return pulley 123, always only one sleeve is transferred to the loading standby part (not shown), continuously.

Though the apparatus for automatic loading of a sleeve on a device testing apparatus 100 of the present invention is explained as applied to the device testing apparatus having a system as explained in the related art, the apparatus for automatic loading of a sleeve on a device testing apparatus 100 of the present invention can be applicable to device testing apparatuses of different systems as an individual module, once a part thereof, for an example, the conveyor device which loads sleeves at the loading standby part on a loading part of the device testing apparatus is modified, appropriately.

As has been explained, the automatic transportation, and loading of the sleeves onto the loading part one by one once the user puts the sleeves on the sloped loading plate 101 of the apparatus of the present invention as the user likes without lining up improves working and testing efficiencies.

Moreover, the apparatus for automatic loading of a sleeve on a device testing apparatus of the present invention may be modified to serve to general purpose as an individual module use of which is not limited by a system of the device testing apparatus by modifying a part thereof.

It will be apparent to those skilled in the art that various modifications and variations can be made in the apparatus for automatic loading of a sleeve on a device testing apparatus of the present invention without departing from the spirit or scope of the invention. Thus, it is intended that the present invention cover the modifications and variations of this invention provided they come within the scope of the appended claims and their equivalents.

What is claimed is:

1. An apparatus for automatic loading of a sleeve on a device testing apparatus comprising:
a sloped loading plate for putting sleeves each having devices held therein thereon;
vertical fixation plates at both sides of the sloped loading plate;
carrier means fitted so as to be in contact with a lower edge of the sloped loading plate, for holding the sleeves put on, and slid down to the lower edge of, the sloped loading part, and transporting to a loading part in the device testing apparatus one by one in succession; and,
driver means fitted to the fixation plate for driving the carrier means.

2. An apparatus as claimed in claim 1, wherein the carrier means includes;
a driver shaft fitted across upper parts of the fixation plates having one end rotatably coupled to the motor;
one pair of upper pulleys fixed to both ends of the driver shaft for rotation together with the driver shaft;
a follower shaft rotatably fitted across lower parts of the fixation plates;
conveyor belts connected between the upper pulleys and the lower pulleys and fitted so as to be almost in contact with the lower edge of the sloped loading plate; and
steps fitted to outside surfaces of the conveyor belts at fixed intervals for lifting and transporting the sleeves at the lower edge of the sloped loading plate during the conveyor belts are moving.

3. An apparatus as claimed in claim 2, further comprising return means for, when a plurality of sleeves on the sloped loading plate are loaded on, and transported by the step, returning the sleeves back to the sloped loading plate again, leaving only one of the sleeves.

4. An apparatus as claimed in claim 3, wherein return means includes;
a second lower pulley fixed to the follower shaft at an outer side of the lower pulley for rotation with the follower shaft, and
a return pulley rotatably fitted to a middle part of an inner side of the fixation plate so as to be positioned at an outer side of the conveyor belt, connected to the second lower pulley through the second lower pulley for rotation with the second lower pulley, and having a projection at an outside circumference projected to a surface of the conveyor belt for hitting upper sleeves to fall off the step when a plurality of sleeves are loaded on the step of the conveyor belt.

5. An apparatus for automatic loading of a sleeve on a device testing apparatus comprising:
a sloped loading plate for putting sleeves each having devices held therein thereon;
vertical fixation plates at both sides of the sloped loading plate;
carrier means fitted so as to be in contact with a lower edge of the sloped loading plate, for holding the sleeves put on, and slid down to the lower edge of, the sloped loading part, and transporting to a loading part in the device testing apparatus one by one in succession;
driver means fitted to the fixation plate for driving the carrier means; and,
return means for, when a plurality of sleeves on the sloped loading plate are loaded on, and transported by the step, returning the sleeves back to the sloped loading plate again, leaving only one of the sleeves.

6. An apparatus as claimed in claim 1 or 5, further comprising guide rails fitted to tops of the fixation plates for guiding the sleeves being transported to the loading part.
